(19) United States
(12) Patent Application Publication
(10) Pub. No.: US 2025/0314357 A1
(43) Pub. Date: Oct. 9, 2025

(54) SYSTEMS AND METHODS TO REVERSIBLY COUPLE A ROUNDING RING TO A TANK

(71) Applicant: Blue Origin, LLC, Kent, WA (US)

(72) Inventors: Matthew Robert Grimes, Orlando, FL (US); Michael Lagalle, Orlando, FL (US); Clement Marmorat, Arlington, VA (US)

(21) Appl. No.: 18/630,944

(22) Filed: Apr. 9, 2024

(51) Int. Cl. F17C 13/08

(52) U.S. Cl. CPC F17C 13/088; F17C 2201/0109; F17C 2205/0153; F17C 2209/22; F17C 2270/0197

(57) ABSTRACT

A device configured to couple a rounding ring to a tank is provided. In one aspect, the device includes a bracket having a first leg angled relative to a second leg, the first leg comprising a tank-facing side and a first opening, the second leg configured to couple to the rounding ring; a mount comprising a tank-facing side and a stud on a second side opposite the tank-facing side, the tank-facing side of the mount configured to place an adhesive into contact with the tank when the stud is inserted into the first opening of the bracket via the tank facing side of the first leg of the bracket; a spring between the second side of the mount and the tank-facing side of the first leg of the bracket when the stud is inserted into the first opening of the bracket; and a nut configured to couple to the stud and compress the spring when the stud is inserted into the first opening of the bracket and the second leg is coupled to the rounding ring. Movement of the nut away from the mount uncompresses the spring to place adhesive on the tank-facing side of the mount into contact with the tank.

### TECHNOLOGICAL FIELD

The development relates to systems and methods for holding a rounding ring in place with respect to a tank, for example a rocket tank.

### BACKGROUND

Rounding rings are used in aerospace applications to help maintain the round shape of a curved surface, such as a tank, when under stress. In some cases, rounding rings may be referred to as stiffener rings or ring stiffeners.

Rounding rings are commonly positioned circumferentially around a cylindrical body, such as a tank, to assist in holding the tank in a static orientation during welding operations on the tank. Rounding rings can assist to hold a tank in a static horizontal orientation, without moving or slipping during welding operations. Coupling a rounding ring to a tank in a horizontal orientation can be particularly challenging, however, because rounding rings and the tank are subject to movement relative to each other, potentially degrading or ruining the weld. While the rounding rings can be held in place relative to the tank by drilling through the surface of the tank, this is undesirable for many aerospace applications as it would compromise the integrity of the tank surface or damage the tank.

### SUMMARY

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description” one will understand how the features of the embodiments described herein provide advantages over existing approaches.

Disclosed herein are systems and methods for securing rounding rings to a curved surface, such as the surface of a tank, during circumferential welding, including horizontal circumferential welding. The systems and methods of the present disclosure may keep the rounding rings from moving tangentially and/or axially relative to the tank, while allowing the tank to flex during welding operations on the tank. The systems and methods of the present disclosure allow for welding while the tank is in the horizontal position, allowing for welding of parts with much larger diameters than would otherwise be possible.

Systems and methods disclosed herein can be used on any tank, large pressure vessel, or structure that uses circumferential welding in vertical, horizontal, or other configurations.

In some aspects, the techniques described herein relate to a device configured to couple a rounding ring to a tank, the device including: a bracket having a first leg angled relative to a second leg, the first leg including a tank-facing side and a first opening, the second leg configured to couple to the rounding ring; a mount including a tank-facing side and a stud on a second side opposite the tank-facing side, the tank-facing side of the mount configured to place an adhesive into contact with the tank when the stud is inserted into the first opening of the bracket via the tank-facing side of the first leg of the bracket; a spring between the second side of the mount and the tank-facing side of the first leg of the bracket when the stud is inserted into the first opening of the bracket; and a nut configured to couple to the stud and compress the spring when the stud is inserted into the first opening of the bracket and the second leg is coupled to the rounding ring, wherein movement of the nut away from the mount uncompresses the spring to place adhesive on the tank-facing side of the mount into contact with the tank.

In some aspects, the techniques described herein relate to a device, wherein, when the adhesive is placed into contact with the tank, the mount is configured to apply about 2.5 to about 5 pounds per square inch pressure on the adhesive.

In some aspects, the techniques described herein relate to a device, wherein the stud is a threaded stud, and wherein unthreading the nut from the stud moves the nut away from the mount to uncompress the spring.

In some aspects, the techniques described herein relate to a device, wherein the spring is configured to be received around an outer diameter of the stud.

In some aspects, the techniques described herein relate to a device, wherein the second leg of the bracket includes a second opening configured to receive a fastener configured to couple the second leg of the bracket to the rounding ring.

In some aspects, the techniques described herein relate to a device, wherein the device is configured to couple the rounding ring to a tank having an outer diameter of 20 feet or more.

In some aspects, the techniques described herein relate to a system including: a rounding ring positioned around a circumference of a tank; an angled bracket including a tank-facing leg and a ring-facing leg; a flanged post including a first side and a second side, the first side configured to place an adhesive into contact with the tank when the flanged post is inserted into an opening in the tank-facing leg of the angled bracket; an elastic device between the second side of the flanged post and the tank-facing leg of the angled bracket when the flanged post is inserted into the opening of the angled bracket; and a fastener configured to couple to the flanged post and compress the elastic device when the post is inserted into the opening of the angled bracket and the ring-facing leg is coupled to the rounding ring, wherein movement of the fastener away from the tank-facing leg uncompresses the elastic device to place adhesive on the first side of the flanged post into contact with the tank.

In some aspects, the techniques described herein relate to a system, further including a plurality of angled brackets configured to couple the rounding ring to the tank at a plurality of locations around the circumference of the tank.

In some aspects, the techniques described herein relate to a system, wherein the tank-facing leg of a first angled bracket is longer than the tank-facing leg of a second angled bracket of the plurality of angled brackets.

In some aspects, the techniques described herein relate to a system, wherein at least one angled bracket of the plurality of angled brackets couples the rounding ring to the tank every 45 degrees along the circumference of the tank.

In some aspects, the techniques described herein relate to a system, wherein, when the adhesive is placed into contact with the tank, the first side of the flanged post is configured to apply about 2.5 to about 5 pounds per square inch pressure on the adhesive.

In some aspects, the techniques described herein relate to a system, wherein the elastic device includes a helical compression spring configured to be received around an outer diameter of the flanged post.

In some aspects, the techniques described herein relate to a system, further including a second fastener configured to couple the ring-facing leg of the angled bracket to the rounding ring, wherein the ring-facing leg of the angled bracket includes a second opening configured to receive the second fastener.

In some aspects, the techniques described herein relate to a system, wherein the system is configured to couple the rounding ring to a tank having an outer diameter of 20 feet or more.

In some aspects, the techniques described herein relate to a system, wherein the system is configured to allow the tank to deform along an axis of the flanged post when the adhesive on the first side of the flanged post is placed into contact with the tank.

In some aspects, the techniques described herein relate to a system, wherein the system is configured to allow the tank to deform radially with respect to the rounding ring when the adhesive on the first side of the flanged post is placed into contact with the tank.

In some aspects, the techniques described herein relate to a system, wherein the angled bracket is configured to allow the tank to be coupled to the rounding ring when a major axis of the tank is parallel to the ground.

In some aspects, the techniques described herein relate to a method of coupling a rounding ring to a tank, the method including: positioning a rounding ring around a circumference of the tank; providing a kit including an angled bracket including a tank-facing leg and a ring-facing leg, a flanged post including a first side and a second side, the first side configured to place an adhesive into contact with the tank when the flanged post is inserted into an opening in the tank-facing leg of the angled bracket, an elastic device between the second side of the flanged post and the tank-facing leg of the angled bracket when the flanged post is inserted into the opening of the angled bracket, and a fastener configured to couple to the flanged post and compress the elastic device when the post is inserted into the opening of the angled bracket and the ring-facing leg is coupled to the rounding ring, wherein movement of the fastener away from the tank-facing leg uncompresses the elastic device to place adhesive on the first side of the flanged post into contact with the tank; and coupling the tank-facing leg of the angled bracket to the tank and the ring-facing leg of the angled bracket to the rounding ring.

In some aspects, the techniques described herein relate to a method, wherein coupling the tank-facing leg of the angled bracket to the tank and the ring-facing leg of the angled bracket to the rounding ring includes: positioning the elastic device around the flanged post; inserting the flanged post into an opening in the tank-facing leg of the angled bracket such that the elastic device is positioned between the second side of the flanged post and the tank-facing leg of the angled bracket; compressing the elastic device between the second side of the flanged post and the tank-facing leg of the angled bracket; coupling the ring-facing leg of the angled bracket to the rounding ring; placing an adhesive on the first side of the flanged post; and uncompressing the elastic device to place the adhesive into contact with the tank.

In some aspects, the techniques described herein relate to a method, wherein the kit further includes a fastener configured to couple to the flanged post.

In some aspects, the techniques described herein relate to a method, wherein compressing the elastic device between the second side of the flanged post and the tank-facing leg of the angled bracket includes fastening the fastener to the flanged post.

In some aspects, the techniques described herein relate to a method, wherein uncompressing the elastic device includes unfastening the fastener from the flange post.

In some aspects, the techniques described herein relate to a method, wherein uncompressing the elastic device applies about 2.5 to about 5 pounds per square inch pressure on the adhesive in contact with the tank.

In some aspects, the techniques described herein relate to a method, further including using a cryogenic technique to remove the adhesive in contact with the tank.

In some aspects, the techniques described herein relate to a method, further including coupling the rounding ring to the tank at a plurality of locations around the circumference of the tank using a plurality of kits.

In some aspects, the techniques described herein relate to a method, wherein the rounding ring is coupled to the tank at every 45 degrees along the circumference of the tank using at least one kit.

In some aspects, the techniques described herein relate to a method, wherein the tank has an outer diameter of 20 feet or more.

In some aspects, the techniques described herein relate to a method, wherein the tank is in a vertical orientation when the rounding ring is coupled to the tank.

### BRIEF DESCRIPTION OF THE DRAWINGS

The foregoing and other features of the present disclosure will become more fully apparent from the following description and appended claims, taken in conjunction with the accompanying drawings. In the drawings, similar symbols typically identify similar components, unless context dictates otherwise. Understanding that these drawings depict only several embodiments in accordance with the disclosure and are not to be considered limiting of its scope, the disclosure will be described with additional specificity and detail through use of the accompanying drawings. Other embodiments may be implemented in accordance with the present disclosure, and other changes may be made, without departing from the spirit or scope of the present disclosure. It will be readily understood that the aspects of the present disclosure, as generally described herein, and illustrated in the figures, can be arranged, substituted, combined, and designed in a wide variety of different configurations, all of which are explicitly contemplated and make part of this disclosure.

FIG. 1A illustrates an example welding environment.

FIG. 1B illustrates an example portion of an example tank and rounding ring.

FIGS. 2A and 2B illustrate perspective and elevation views, respectively, of an example set of bracket assemblies attached to a rounding ring in accordance with the present disclosure.

FIGS. 3A and 3B illustrate perspective and exploded views of an example bracket assembly in accordance with the present disclosure.

FIG. 4 illustrates a perspective view of an example bracket assembly secured to a rounding ring and a tank in accordance with the present disclosure.

FIGS. 5A-5C illustrate perspective views of various embodiments of an example bracket assembly in accordance with the present disclosure.

FIG. 6 is a flowchart of an example method of applying a bracket assembly to a rounding ring and/or tank in accordance with the present disclosure.

FIGS. 7A-7E illustrate cross-sectional views during application and removal of a bracket assembly to a rounding ring and/or tank in accordance with the present disclosure.

FIG. 8 illustrates an example system for removing adhesive after removing a bracket assembly in accordance with the present disclosure.

### DETAILED DESCRIPTION

Systems, devices, and methods for reversibly coupling a rounding ring to a structure, such as a tank, in accordance with embodiments of the present disclosure can provide solutions to problems with existing coupling mechanisms and various advantages over existing devices. Existing coupling mechanisms are ineffective to consistently and securely couple the rounding ring to the tank, causing the rounding ring to slip or move during welding operations on the tank, adversely affecting weld quality and causing costly delays. Ineffective coupling between a rounding ring and a horizontally-oriented tank can also cause the tank to deform or “oval,” introducing risk of damage to the tank. Advantageously, devices according to the present disclosure, sometimes referenced herein as bracket assemblies, can be positioned and coupled to the rounding ring and the tank in a reliable process that requires minimal time, uses cost-effective components, and adapts to the specific physical conditions of the tank at each installation location. Bracket assemblies according to the present disclosure can be modular, such that each of plurality of bracket assembly kits with common components can be installed in any of a plurality of locations around the tank surface.

Once installed, bracket assemblies according to the present disclosure have a very low profile relative to the rounding ring, such that they do not interfere with welding or other operations performed in their vicinity. Advantageously, embodiments of bracket assemblies according to the present disclosure prevent the rounding ring from slipping or moving relative to the tank during operations on the tank, such as circumferential welding on the tank. Rounding rings coupled to tanks using bracket assemblies according to the present disclosure effectively prevent the rounding ring from moving tangentially and axially relative to the tank, while still allowing the tank wall to flex. As a result, embodiments of bracket assemblies according to the present disclosure can allow for circumferential welding of horizontally-oriented tanks having a much larger diameter and/or significantly reduced wall thickness than is possible using existing systems.

Bracket assemblies according to the present disclosure are particularly advantageous because they allow the rounding ring to be uncoupled from the tank without permanently altering or damaging the surface of the tank. For example, bracket assemblies according to the present disclosure do not puncture the tank wall, do not negatively impact the surface of the tank while coupled to the tank or after being uncoupled from the tank, and allow for painting over the tank surfaces where the bracket assemblies were previously coupled to the tank.

Systems, devices, and methods according to the present disclosure include a bracket assembly that includes a mount and a bracket. The mount is reversibly coupled to a tank-facing leg of the bracket and is also reversibly coupled to the tank via an adhesive. A ring-facing leg of the bracket is also reversibly coupled to a rounding ring that is positioned around an outer diameter of the tank. The adhesive is configured to couple the tank-facing leg of the bracket to the tank (via the mount), without permanently damaging or adversely affecting the tank when the bracket assembly and the rounding ring are uncoupled from the tank. Bolts or other fasteners configured to couple the ring-facing leg of the bracket to the rounding ring are also reversible, allowing the bracket assembly to be uncoupled from the rounding ring in a way that allows the rounding ring and the bracket assembly to be re-used in a second installation. Advantageously, embodiments of bracket assemblies according to the present disclosure include an elastically deformable component, such as a spring, that is configured to impart relative motion between the bracket and the mount during a procedure to couple the rounding ring and the tank using the bracket assembly. This relative motion can cause adhesive positioned on a tank-facing side of the mount to come into contact with the tank. The force exerted on the mount by the spring can maintain a minimum pressure on the adhesive as it cures, creating a secure yet reversible bond between the tank-facing leg of the bracket and the tank. Systems according to the present disclosure can include a plurality of angled brackets configured to couple the rounding ring to the tank at a plurality of locations around the circumference of the tank. Advantageously, the system can provide a reversible bond between the rounding ring and the tank because the brackets and the adhesive-bonded mounts of each bracket can be removed by: uncoupling the fasteners coupling the ring-facing side of the bracket to the rounding ring; uncoupling the mount from the tank-facing side of the bracket; and uncoupling the adhesive-bonded mount from the tank.

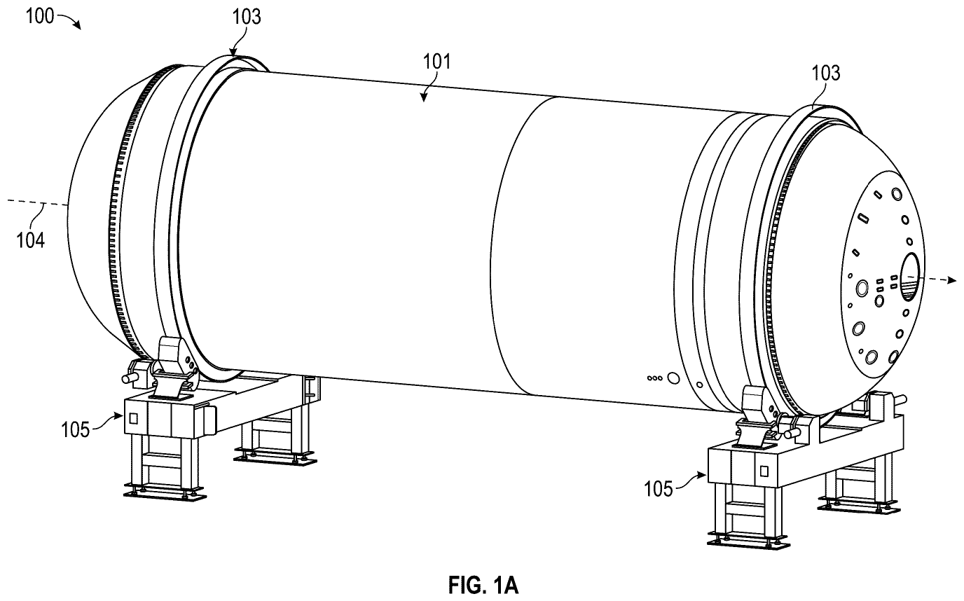

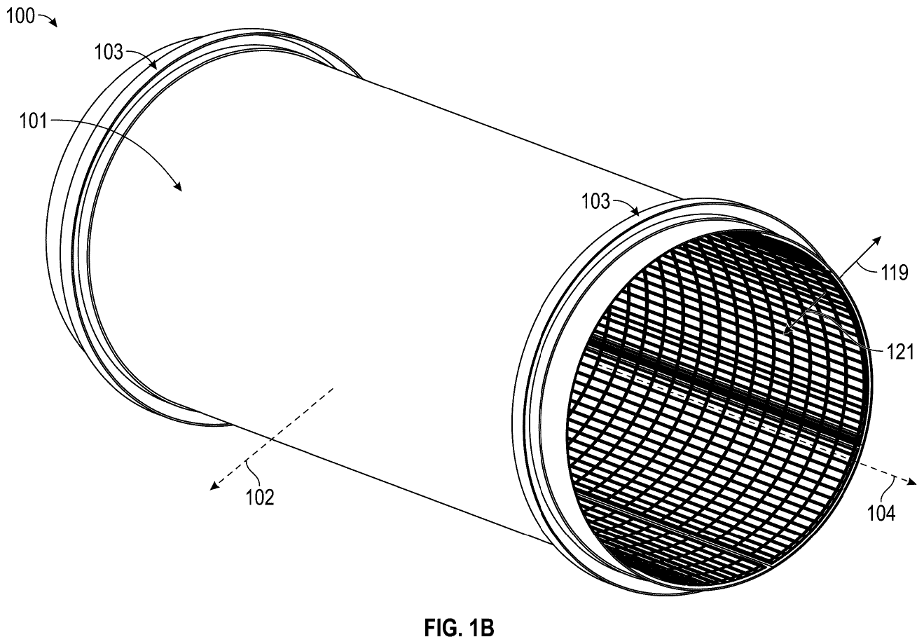

Example systems, devices, and methods for reversibly coupling a rounding ring to a tank in accordance with the present disclosure will now be described. FIG. 1A illustrates an example welding environment in which systems, devices, and methods according to the present disclosure may be applied. FIG. 1B illustrates an example segment or portion of a tank 101 and two example rounding rings 103 coupled to the tank 101. Referring to FIG. 1A, a welding environment 100 can include a tank 101 to be reversibly coupled to one or more rounding rings 103 positioned around the exterior surface of the tank 101. It will be understood that embodiments of the present disclosure are not limited to devices that couple a rounding ring to a tank 101, and can be suitably implemented with any component having a surface to be coupled to a rounding ring, such as but not limited to a barrel, a cylinder, a square object, and a rectangular object. It will also be understood that embodiments of the present disclosure are not limited to rounding rings 103 having a circular or ring-like shape, and can be suitably implemented to couple other types of structures to a surface of another structure (such as a tank). For example, embodiments of the present disclosure can couple a first structure to a second structure, where the first structure is configured to provide structural support to the second structure. Non-limiting examples of the first structure can include a partial ring section, a square band, and a rectangular band. Non-limiting examples of the second structure can include a tank, a barrel, a structure with a square cross-section, and a structure with a rectangular cross-section.

In some examples, such as that illustrated in FIGS. 1A and 1B, the tank 101 may be substantially hollow. The tank 101 can be configured to store a gas or liquid. The tank 101 can be configured to be assembled in pieces, for example by welding individual pieces. An outer diameter of a tank 101 can be 10, 15, 20, or 25 feet or any value or range within or bounded by any of these ranges or values, although values outside these values or ranges can be implemented in some cases. A thickness of a wall of the tank 101 can be ⅛ inch, ¼ inch, ½ inch, 1 inch, or any value or range within or bounded by any of these ranges or values, although values outside these values or ranges can be implemented in some cases.

Embodiments of the present disclosure can be particularly advantageous when the tank 101 is oriented horizontally (for example, where a longitudinal axis 104 along a length of the tank 101 is approximately parallel to the ground, such as shown in FIGS. 1A and 1B). In some examples, a thickness of the tank wall in relation to the outer diameter of the tank can be such that, when the tank 101 is oriented horizontally (such as along axis 104), the tank 101 may deform, flex, or displace due to gravitational forces causing circumferential stress or hoop stress. Circumferential stress of the tank wall can make maintaining the position of a rounding ring relative to the tank wall particularly challenging. Prior devices and/or coupling mechanisms for maintaining the position of a rounding ring to the tank wall may not be reliable, may fail or degrade over time, or may cause damage to the tank wall because of circumferential stress of the tank wall. Challenges associated with circumferential or hoop stress due to gravity can have a proportionately more significant impact with increased tank diameter and/or decreased wall thickness. In aerospace applications, where tolerances are typically very low, deformation and/or flexing due to circumferential or hoop stress can become a significant issue during horizontal circumferential welding. Systems and methods according to the present disclosure can advantageously mitigate or eliminate challenges associated with maintaining the position of a rounding ring relative to a tank while the tank is positioned horizontally and/or subject to significant quantities of circumferential stress.

Embodiments of the present disclosure include one or more rounding rings 103 configured to provide structural support to the tank 101. The rounding ring 103 may provide support temporarily or permanently. In some examples, the rounding ring 103 may be referred to as a stiffener ring, ring stiffener, reinforcing ring or the like. The structural support provided by the rounding ring 103 may include support to maintain a shape of the tank 101, such as a circular cross section of the tank 101 or other initial shape of the tank 101. For example, the rounding ring 103 may provide circumferential reinforcement to help prevent modes of failure of the tank 101 during use or during work (for example, welding operations) on the tank 101, such as the type of deformation described above due to hoop stress, or local buckling, or overall buckling. The rounding ring 103 can provide temporary structural support during welding operations on the tank 101. Advantageously, embodiments of the present disclosure can allow the rounding ring to provide temporary structural support without damaging the tank, while also preventing the rounding ring from slipping or moving during circumferential horizontal welding on the tank 101 or components of the tank 101.

The welding environment 100 can include one or more pieces of machinery 105 to hold or manipulate the rounding ring 103 and/or the tank 101 during fabrication, maintenance, testing, or other work on the tank 101. For example, the machinery 105 may hold the rounding ring 103 while it is coupled to the tank 101 so that horizontal circumferential welding may be performed on the tank 101. The machinery 105 illustrated in FIG. 1A is only illustrative and machinery 105 can include a horizontal circumferential welding machine and/or any other holder, machine, clamp, or the like configured to provide at least some support to the tank 101 and/or rounding ring 103.

Bracket assemblies according to embodiments of the present disclosure can couple the rounding ring 103 to the tank 101 temporarily or permanently. For example, the rounding ring 103 can be reversibly coupled to the tank 101, or permanently coupled to the tank 101. In examples where the rounding ring 103 is reversibly coupled to the tank 101, bracket assemblies according to embodiments of the present disclosure can advantageously allow the rounding ring 103 to be coupled to, and uncoupled from, the tank 101 without permanently changing, impacting, or damaging the tank wall. In the context of aerospace applications, coupling the rounding ring 103 to the tank 101 presents challenges due to the need to limit structural and/or surface damage to the tank 101 during removal of the rounding ring 103 (and the associated coupling mechanism). For example, coatings of the tank 101 may be damaged during installation and/or removal of a coupling mechanism, or coupling mechanisms may require drilling a hole through a wall of the tank 101, which can result in structural damage. Puncturing holes in the wall of the tank 101 may not be feasible in the aerospace context due to permanent, irreversible damage to the integrity of the tank wall. Advantageously, systems and methods according to the present disclosure can reversibly couple a rounding ring 103 to the tank 101 using a bracket assembly that can be removed after the rounding ring is no longer needed, with no or limited structural and/or surface damage to the tank 101.

FIG. 1B illustrates an example orientation of rounding rings 103 relative to a section of the tank 101, prior to coupling the rounding rings 103 to the tank 101 in accordance with embodiments of the present disclosure. Once installed, bracket assemblies according to the present disclosure can prevent the rounding rings 103 from moving tangentially relative to the tank 101 (along arrow 102) and/or axially relative to the tank 101 (along the longitudinal axis 104) and/or rotating about the longitudinal axis 104 of the tank 101, while at the same time allowing the tank wall to flex in the radial directions, for example along arrows 119 and/or 121. Advantageously, systems and methods according to the present disclosure can prevent movement of the rounding rings 103 without damage to the tank 101, while the tank 101 is held in a substantially horizontal position, including in examples where the tank 101 is greater than 20 feet in length and/or has a wall thickness of less than 1 inch.

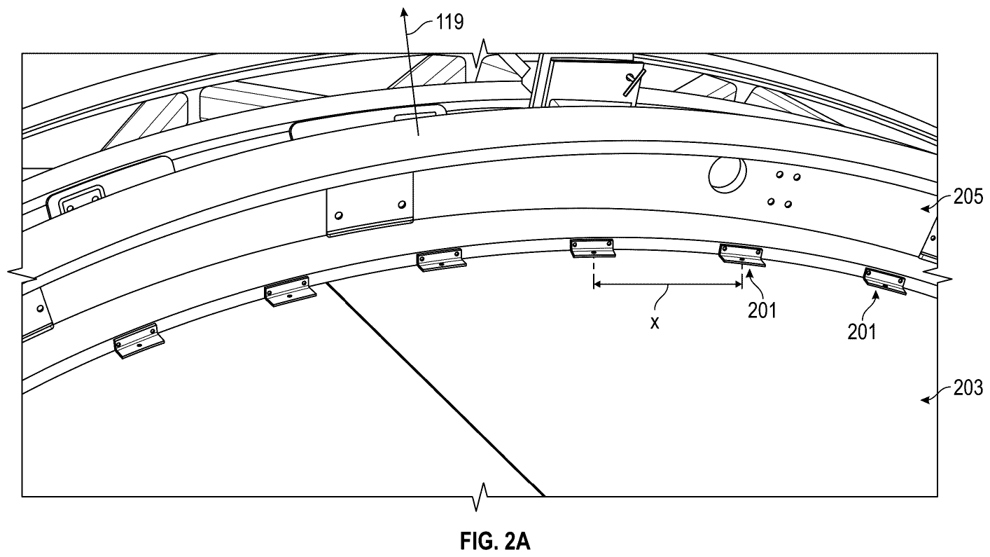

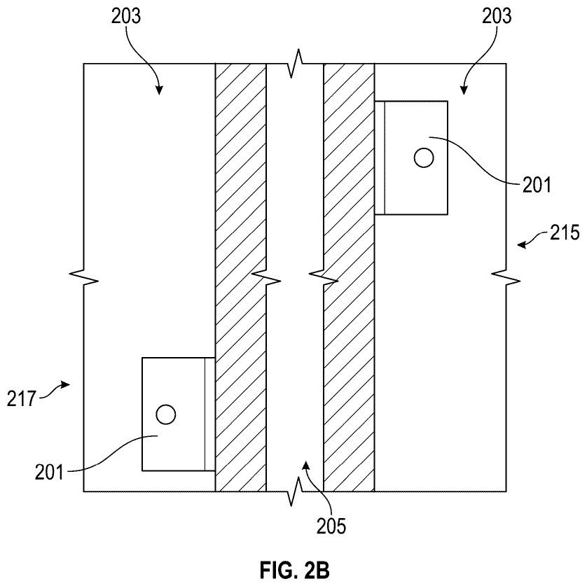

FIGS. 2A and 2B illustrate perspective and elevation views of an example coupling mechanism configured to couple a rounding ring 205 to a tank 203 in accordance with an embodiment of the present disclosure. The elevation view of FIG. 2B illustrates a view toward the external surface of the tank 203 in the radial direction (for example, along arrow 219 illustrated in FIG. 2A). In the illustrated example, the coupling mechanism includes a bracket assembly 201 according to the present disclosure. As illustrated, a plurality of bracket assemblies 201 can be applied at intervals along the interface between the tank 203 and the rounding ring 205.

In some examples, an interval or spacing X between the bracket assemblies 201 may be regular or periodic. In some configurations, the interval or spacing X will be as even around the circumference of the tank as the tank geometry will allow. However, interval X spacing may or may not be consistent or even. In other examples, the interval X between the bracket assemblies 201 may be varied. In some examples, the bracket assembly 201 may be applied at intervals or spacings X in groups, such as a first group of 2 or 3 bracket assemblies 201 applied at a first interval or spacing X1 and a second group of 2 or 3 bracket assemblies 201 applied at a second interval or spacing X2 that is different than X1. Advantageously, the interval X between the bracket assemblies 201, and the number of bracket assemblies 201 applied to the tank 203 and the rounding ring 205, can be selected based on a geometry of the tank 203 and/or the rounding ring 205. A placement of the bracket assemblies 201 may additionally or alternatively be dependent on other considerations, such as locations of areas of interest on a tank 203 or the like. The interval X may be approximately 1, 2, 3, 4, 5, 6, 7, 8, 9, or 10 feet or any value or range within or bounded by any of these ranges or values, although values outside these values or ranges can be suitably implemented. The interval X may be an arc length, or angle interval, along a circumference of the tank, such as every 45 degrees along the circumference of the tank. In one example implementation, a bracket assembly 201 is applied at an interval of 45 degrees around the circumference of the tank, for a total of eight bracket assemblies evenly distributed around the tank. In another example implementation, a group of two bracket assemblies 201 is placed at an interval of 45 degrees around the circumference of the tank, for a total of sixteen bracket assemblies evenly distributed in groups of two around the tank. In still another example implementation, one bracket assembly is placed at an interval of 22.5 degrees around the circumference of the tank, for a total of sixteen bracket assemblies evenly distributed around the tank. However, other intervals and implementations are also possible. The placement of one or more bracket assemblies 201 and/or groups of bracket assemblies 201 may be selected based on parameters such as size, weight, and/or forces on the tank. For example, a minimum number of bracket assemblies 201 applied to the tank may be three or four bracket assemblies for a light tank with a small diameter that is exposed to low forces. In another example, a maximum number of bracket assemblies 201 may be bounded by the physical space available on the tank to fit bracket assemblies 201.

A total number, size, and/or location of bracket assemblies 201 may be varied based on geometry, application, or other considerations. While the illustrated bracket assemblies 201 are shown as approximately the same size and shape, bracket assemblies 201 can be different in one or more dimensions or features. In some examples, a size, dimension, or feature of a bracket assembly 201 may be dependent on features of the tank 203 and/or the rounding ring 205.

As illustrated in FIG. 2B, bracket assemblies 201 can be placed with respect to the rounding ring 205 on either side 215, 217 of the rounding ring 205. In one example implementation, a bracket assembly 201 is only placed on a non-welding side of the rounding ring 205 or a side 215 or 217 at which a weld will not be placed. For example, a weld may be placed at a side 215 and a bracket assembly 201 may be placed at a side 217 or vice versa. In the illustrated example, the sides 215, 217 are shown as opposite each other and/or substantially parallel with respect to each other. A bracket assembly 201 on one side 215 of the rounding ring 205 may be installed and/or mounted in one installation location, and a bracket assembly 201 on a second side 217 of the rounding ring 205 may be installed and/or mounted in a second installation location. The first and second installation locations may be displaced by a distance 216. The distance 216 between adjacent bracket assemblies 201 of a plurality of bracket assemblies 201 can be regular or irregular. Thus, a variation in the tank 203 surface near the first and/or second installation locations (near or at the first or second sides 215, 217 of the rounding ring 205) may be accounted for and/or avoided. In some examples, the rounding ring 205 may include mounting locations for the bracket assemblies 201 on just the first side 215, just the second side 217, or both the first and second sides 215, 217 of the rounding ring 205 to allow for variability in application of the bracket assemblies 201.

One or more bracket assemblies 201 may be used in conjunction with and/or in the alternative to other methods of coupling a tank 203 and a rounding ring 205. While a tank 203 and a rounding ring 205 are discussed herein, embodiments of the bracket assembly 201 in accordance with present disclosure can be applicable to other coupling applications, in particular those requiring non-damaging and/or temporary coupling of two or more components.

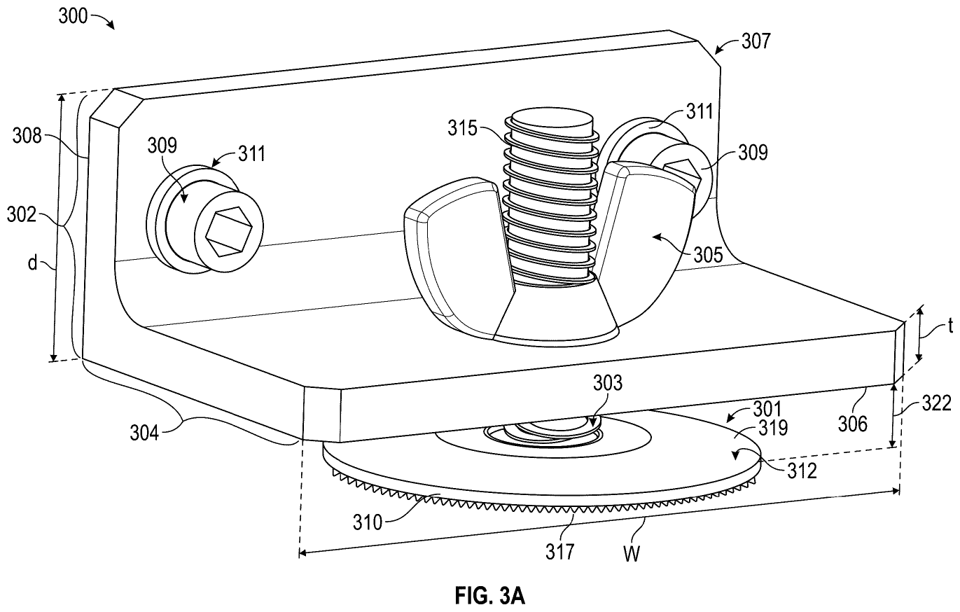

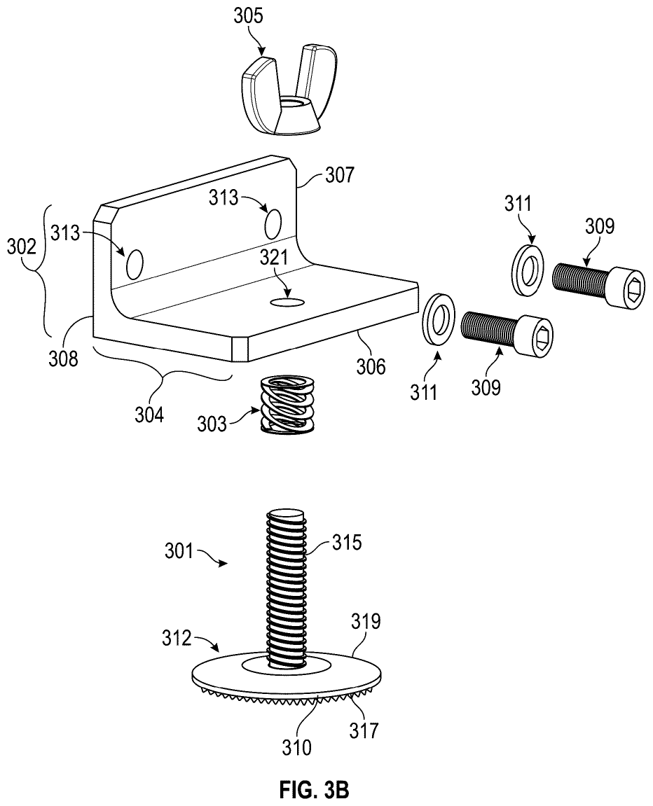

FIGS. 3A and 3B illustrate perspective and exploded views of an example bracket assembly 300 according to an embodiment of the present disclosure. The bracket assembly 300 can include any of the features described with reference to bracket assembly 201. The bracket assembly 300 can include a plurality of components. In this non-limiting example, the bracket assembly 300 includes a bracket 307, for example an angled bracket. The bracket assembly also includes a mount 301, an elastically deformable component such as a spring 303, and a fastener 305 (such as a nut). In some implementations, the bracket assembly 300 can also include one or more fasteners 309 and one or more washers 311. The fasteners 309 can include bolts, screws, or any other suitable fastener.

The bracket 307 can include a first leg 304, also referred to herein as a tank-facing leg. The first leg 304 is angled relative to a second leg 302, also referred to herein as a ring-facing leg. The first leg 304 can include a tank-facing side 306 and the second leg 302 can include a ring-facing side 308. The first leg 304 includes one or more first openings 321. The second leg 302 includes one or more second openings 313. The one or more first openings 321 of the first leg 304 can be configured to receive a stud (or post) 315 of the mount 301. The one or more second openings 313 of the second leg 302 can be configured to receive the one or more fasteners 309. When the bracket assembly 300 is installed to couple a rounding ring to a tank, the first leg 304 can be configured to couple to the tank, for example indirectly couple to the tank via the mount 301. The first leg 304 may not physically contact the tank. The second leg 302 can be configured to couple to the rounding ring, for example directly couple to the rounding ring with the one or more fasteners 309. The second leg 302 may physically contact the rounding ring. Other configurations can be suitably implemented. For example, the second leg 302 can be configured to indirectly couple to the rounding ring, for example via a mount similar to mount 301, an elastically deformable component such as a spring, or another suitable component in accordance with the present disclosure.

In some examples, the first leg 304 of the bracket 307 can be perpendicular or substantially perpendicular to the second leg 302. The first leg 304 can be angled relative to the second leg 302 at other angles. The bracket 307 can be an L-shaped bracket. The bracket 307 can be formed of any suitable material, for example, but not limited to, metal, plastic, or wood. The bracket 307 can have any suitable dimensions. In one non-limiting example, the bracket 307 has an overall length L1 of approximately 2 inches, a width W of approximately 3.25 inches, and a first leg 304 having a length L2 of approximately 1.25 inches.

The mount 301 of the bracket assembly 300 is configured to couple the bracket 307 to the tank. In particular, the mount 301 can reversibly couple the bracket 307 to the tank. The mount 301 includes a tank-facing side 310 and a stud 315 on a second side 312 opposite the tank-facing side 310. The tank-facing side 310 of the mount 301 can be configured to place an adhesive into contact with the tank when the stud 315 is inserted into the first opening 321 of the bracket 307 via the tank-facing side 306 of the first leg 304 of the bracket 307. The mount 301 can be suitably implemented in many different forms in accordance with the present disclosure. For example, in some embodiments of the present disclosure, the mount 301 is a flanged post including a first side and a second side, where the first side is configured to place an adhesive into contact with the tank when the flanged post is inserted into the first opening 321 in the tank-facing leg 304 of the bracket 307.

The stud 315 can be a threaded stud or post. The stud 315 can be configured to couple to the fastener 305, which can be, for example, a threaded nut. The fastener 305 can be any suitable nut, for example a wingnut. In another non-limiting embodiment, the stud 315 is not threaded and is configured to couple to a non-threaded compression ring or other suitable fastener. The tank-facing side 310 of the mount 301 can be located on a flange 319 of the mount 301. In some non-limiting examples, the stud 315 can be coupled to the flange 319. In such non-limiting examples, the flange 319 and the stud 315 can be formed as a single unitary piece, or they can be coupled together to form the mount 301. The flange 319 can include a substantially planar portion that is generally perpendicular to a longitudinal axis of the stud 315. The tank-facing side 310 of the mount 301 can be configured to receive an adhesive 317. For example, the adhesive 317 can be applied to the tank-facing side 310 of the mount 301 during a procedure to couple the tank to the ring using the bracket 307. As will be described below, the tank-facing side 310 of the mount 301 can face a tank to which a rounding ring is coupled, when the bracket 307 is installed to position the rounding ring relative to the tank.

The adhesive 317 may be glue, cement, paste, or any substance configured to be applied to the tank-facing side 310 of the mount 301 and bind, at least temporarily, the tank-facing side 310 of the mount 301 to the tank. The adhesive 317 may be a reactive or non-reactive adhesive. The adhesive may be pliable, flexible, and/or fluid in an uncured state and less pliable, flexible, and/or fluid in a cured state. The adhesive 317 may be configured to cure in a period of minutes to hours. Examples of adhesives include, but are not limited to, two-part thixotropic acrylic paste adhesives, epoxy paste adhesives, and single part cyanoacrylates. The choice of adhesive may depend on the context of the application. For example, the binding strength of an adhesive 317 can be selected based on the thickness of the tank wall. In one non-limiting example suitable for use with a thin-walled tank, an adhesive 317 of relatively weak binding strength is applied to the tank-facing side 310 of the mount 301.

The mount 301 may be, in whole or in part, composed of metal, plastic, or other material. Example non-limiting dimensions of the stud 315 of the mount 301 are approximately 1.475 inches long with a thread size of ⅜-24. Example non-limiting dimensions of the tank-facing side 310 of the mount 301 are approximately 2 inches in diameter and 0.125 inches thick. In another non-limiting example suitable for use with a thin-walled tank, the tank-facing side 310 of the mount 301 is approximately 4 inches in diameter. However other dimensions of the mount 301 are also possible.

The bracket assembly 300 includes an elastically deformable component, such as a spring 303, configured to exert a force on the mount 301. The force exerted by the elastically deformable component, also referenced herein as an elastic device, is configured to impart relative motion between the bracket 307 and the mount 301 during a procedure to couple the rounding ring and the tank. In the non-limiting example described with reference to FIGS. 3A and 3B, the elastically deformable component is configured to exert a force on the second side 312 of the mount 301, causing the mount 301 (including the stud 315) to move toward the tank while the bracket 307 remains stationary. In this non-limiting example, the elastic device includes a spring 303. The spring 303 can include a helical compression spring. The spring 303 is configured to be received around an outer diameter of the stud 315. The spring 303 is configured to be positioned between the second side 312 of the mount 301 and the tank-facing side 306 of the first leg 304 of the bracket 307 when the stud 315 is inserted into the first opening 321 of the bracket 307.

Other elastically deformable components can be suitably implemented in accordance with the present disclosure. For example, in another non-limiting embodiment, the second side 312 of the mount 301 and the stud 315 are not rigidly coupled, and the stud 315 can include an internal elastic device configured to exert a force that moves the second side 312 of the mount 301 toward the tank while the stud 315 remains stationary relative to the first leg 304 of the bracket 307.

The bracket assembly 300 also includes a fastener 305 that is configured to couple to the stud 315 of the mount 301. The fastener 305 can be configured to adjustably couple to the stud 315. In one non-limiting example, the fastener 305 includes a nut configured to adjustably couple to the stud 315. In cases where the stud 315 includes threads, the fastener 305 can be a threaded nut, such as a threaded wingnut. In cases where the stud 315 does not include threads, the fastener 305 can be configured to move along, for example, slide along, an outer surface of the stud 315. As will be described in greater detail below, during a procedure to couple the rounding ring to the tank using the bracket assembly 300, the fastener 305 can be configured to move relative to the stud 315 and compress the spring 303 when the stud 315 is inserted into the first opening 321 of the bracket 307 and the second leg 302 is coupled to the rounding ring. As will also be described in greater detail below, movement of the fastener 305 away from the first leg 304 can uncompress the spring 303 to place the adhesive 317 on the tank-facing side 310 of the mount 301 into contact with the tank.

In this non-limiting example in which the spring 303 is received around an outer diameter of the stud 315, the spring 303 exerts a spring force along the longitudinal axis of the stud 315 when the spring 303 is compressed. When the stud 315 of the mount 301 is passed through the opening 321 of the bracket 307 and coupled with the fastener 305, the spring 303 is held under tension between the second side 312 of the mount 301 and the tank-facing side 306 of the first leg 304 of the bracket 307. When assembled, the fastener 305 and the spring 303 can hold the mount 301, and in particular the tank-facing side 310 of the mount 301, in a variable position relative to the first leg 304 of the bracket 307, with the variable position determined by how far the fastener 305 is threaded on the stud 315 and the amount the spring 303 is compressed.

In implementations of the present disclosure, the bracket assembly 300 is assembled before coupling the bracket assembly 300 to a tank and a rounding ring. To pre-assemble the bracket assembly 300, the spring 303 is installed around the stud 315 of the mount 301, the stud 315 is inserted in the opening 321 via the tank-facing side 306 of the first leg 304 of the bracket 307, and the fastener 305 is coupled to the stud 315, such that the second side 312 of the mount 301 is displaced from the tank-facing side 306 of the first leg 304 by a distance 322. The distance 322 can be selected to provide a predetermined amount of compression on the spring 303, and therefore hold the mount 301 under compression relative to the bracket 307. The compressed spring 303 may then be released during installation of the bracket assembly 300 to couple a rounding ring to a tank. This can provide an associated amount of force against the second side 312 of the mount 301 so that the tank-facing side 310 of the mount 301 applies a pressure on an adhesive in contact with the tank. When the spring 303 is released, the mount 301 can be configured to apply a force on the adhesive that is about 1, 2, 3, 4, 5, 6, 7, 8, 9, or 10 pounds per square inch (psi) pressure, or any value or range within or bounded by any of these ranges or values, although values outside these values or ranges can be implemented in some cases. In one non-limiting example, the mount 301 is configured to apply about 2.5 to about 5 psi pressure on the adhesive. A choice of spring and associated spring constant may additionally be a consideration in determining the amount of compression. It will also be understood that a surface area and shape of the tank-facing side 310 of the mount 301 can be selected to achieve a selected pressure, or range of pressure, when the spring 303 is released. For example, in implementations in which the mount 301 includes a flange 319, the surface area and shape of the flange that contacts the adhesive can be selected to achieve a selected pressure, such as but not limited to about 2.5 to about 5 psi pressure, on the adhesive.

Advantageously, embodiments of the present disclosure can reliably and consistently apply the selected pressure to the adhesive while the adhesive cures, for example during a time period during which the adhesive changes from an uncured state to a cured state. The pressure may be a constant, or substantially constant, minimum pressure during curing of the adhesive. Applying pressure to the adhesive at a predictable, reliable, and/or consistent psi pressure in accordance with embodiments of the present disclosure has many advantages, including but not limited to formation of a more reliable, and therefore, stronger bond; creation of a strong bond despite irregularities in the surface and/or small movements of the tank; and assurance that each bracket assembly of a plurality of bracket assemblies coupling the rounding ring to the tank is providing a minimum psi pressure to each position on the tank where a bracket is installed.

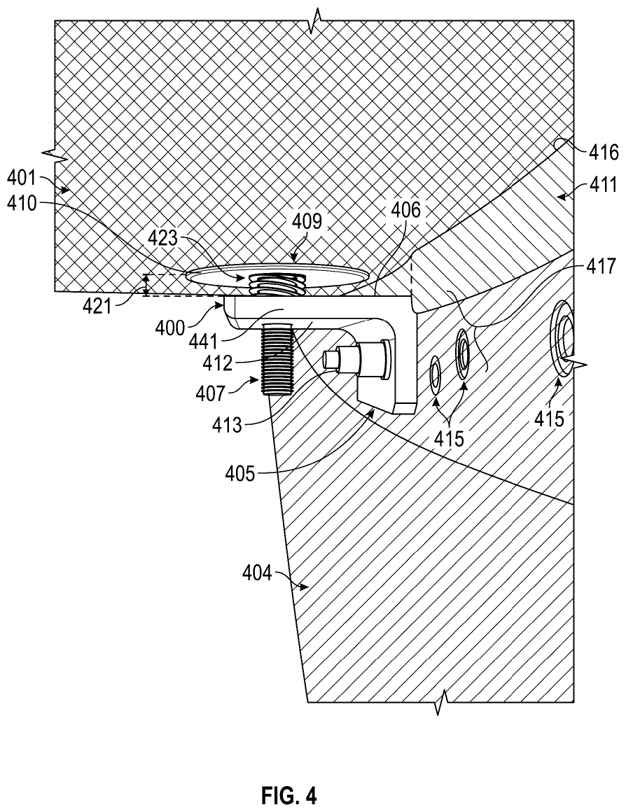

FIG. 4 illustrates a perspective view of an example bracket assembly secured to a rounding ring and a tank in accordance with the present disclosure. In this non-limiting embodiment, a rounding ring 404 is secured to an exterior surface of a tank 401 using a plurality of bracket assemblies 400. The bracket assemblies 400 can include any of the features described with reference to bracket assembly 201 and/or bracket assembly 300. FIG. 4 illustrates an exterior surface of the tank 401 where a portion of the rounding ring 404 has been secured to the tank 401 using one of the bracket assemblies 400.

One or more bracket assemblies 400 can be configured to be placed approximately at an intersection 416 between a tank 401 and gasket 411. The gasket 411 can be positioned between an interior surface of the rounding ring 404 and the exterior surface of the tank 401. Each of the bracket assemblies 400 can be placed at the intersection 416 based on one or more geometric factors or requirements of the bracket assembly and/or tank 401 geometry and/or rounding ring 404 geometry. Additionally and/or alternatively, the use of an elastic device 423 as part of the bracket assembly 400 can allow for use of less precise tolerances in placement of the bracket assembly 400. An elastic device 423 can include but is not limited to a spring. For example, the local conditions of the tank 401 can be different at each intended bracket assembly location. The elastic device 423, such as a spring 303 as illustrated in FIGS. 3A and 3B, can account for variations in the local conditions by allowing the elastic device 423 to decompress a variable amount depending on a distance 421 between the surface of the tank 401 and the tank-facing side 406 of the first leg 441 of the bracket 405 at the specific location where the bracket assembly 400 will be installed. Thus, the bracket assembly 400 can account for variations in local conditions of the tank 401 without requiring extra measurements and/or machining to account for local variations. Further, a plurality of identical or similar bracket assemblies 400 can be prepared for use in coupling the tank 401 to the rounding ring 404 at differing locations on the tank 401, without the need to modify the bracket assemblies 400 for use at each individual location. Advantageously, bracket assemblies 400 according to the present disclosure can be modular, or interchangeable, such that a plurality of bracket assemblies 400 can be prepared for installation, and then any one of the prepared bracket assemblies 400 can be installed at any of a plurality of locations on the tank 401, irrespective of variations in local conditions at each location.

The distance 421 between the surface of the tank 401 and the tank-facing side 406 of the first leg 441 may be greater than a depth to which a fastener is coupled to a stud of the mount (for example, the distance 322 described with reference to the bracket assembly 300 of FIGS. 3A and 3B). As noted with reference to the bracket assembly 300, the distance 322 can be selected to provide a predetermined amount of compression on the spring 303, and therefore hold the mount 301 under compression relative to the bracket 307. Turning back to the bracket assembly 400, when the spring or other elastic device 423 is released to allow for decompression, adhesive on the mount 407 of the bracket assembly 400 is configured to be pressed into the surface of the tank 401 by a force equivalent to the spring force associated with the distance 322 to which the fastener was coupled to the stud of the mount 407 (which is proportional to the degree of compression of the elastic device 423).

The placement of the bracket assembly 400 can be such that a gasket 411 at the intersection 416 can be at least partially compressed by the bracket assembly 400. Additionally or alternatively, the placement of the bracket assembly 400 can be such that a gasket 411 at the intersection 416 remains uncompressed by the bracket assembly 400. The gasket 411 may provide protection to the surface of the tank 401 from the interior surface of the rounding ring 404. It will be understood, however, that a gasket 411 may or may not be present at the intersection 416.

A tank-facing side 410 of the mount 407 of the bracket assembly 400 can be configured to couple to the tank 401 through an adhesive 409. The adhesive 409 can be applied to secure or couple the bracket assembly 400 to the tank 401. The adhesive 409 may be applied after the bracket assembly 400 is coupled to the rounding ring 404. The adhesive 409 may be applied before the elastic device 423 is decompressed. The adhesive 409 may be applied to the surface of the tank 401 and/or the tank-facing side 410 of the mount 401, before the elastic device 423 is decompressed. Accordingly, the adhesive 409 may be arranged between the surface of the tank 401 and the tank-facing side 406 of the first leg 441 of the bracket 405 in any suitable manner. Once cured, the adhesive 409 may form a bond or coupling between the bracket assembly 400 (in particular the tank-facing side 410 of the mount 407) and the surface of the tank 401.

Advantageously, in cases that implement a plurality of bracket assemblies 400, the sequence of application of each bracket assembly 400 can be flexible such that some or all bracket assemblies 400 can be secured to the rounding ring 404 prior to securing the bracket assemblies 400 to the tank 401. For example, the adhesive 409 may be applied to the tank-facing side 410 of the mount 407, then the bracket assembly 400 may be secured to the rounding ring 404, and the fastener (such as a fastener 431) may be loosened so as to allow the adhesive 409 on the tank-facing side 310 of the mount 407 to contact the tank 401. This process of applying the adhesive 409 to the tank-facing side 410 of the mount 407 and then bringing the tank-facing side 410 of the mount 301 into contact with the tank 401 may be performed within a period of time less than the curing time of the adhesive 409, such as less than 30-60 minutes. In some examples, two or more bracket assemblies 400 may be applied to the rounding ring 404 in sequence and then the elastic device 423 of each applied bracket assembly 400 may be released (or allowed to decompress) to allow the tank-facing side 410 of the mount 407 of each bracket assembly 400 to make physical contact with the surface of the tank 401 (via the adhesive 409). Additionally or alternatively, bracket assemblies 400 may be applied completely in turn (for example, the elastic device 423 of two or more bracket assemblies 400 may be released so that adhesive makes physical contact with the surface of the tank 401 as each of the bracket assemblies 400 are applied to the rounding ring 404).

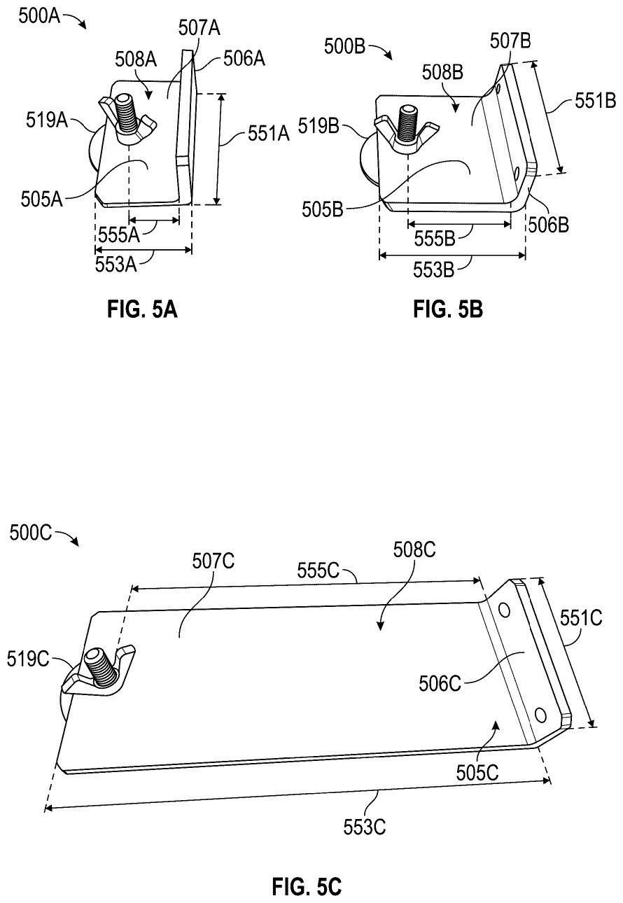

In some examples, one or more bracket assemblies 400 may include differing dimensions. These variations can facilitate flexibility in placement and use of bracket assemblies. Advantageously, the different bracket assemblies 400 may allow a user to couple the tank 401 and the rounding ring 404 while accounting for surface variations, structural differences, or other differences in the tank surface. For example, differently-dimensioned bracket assemblies 400 may allow for coupling of the rounding ring 404 to the tank 401 at locations that may otherwise be difficult or impractical to couple a standard-sized bracket assembly or mount, or where it is undesirable or impractical to adhere the adhesive to a particular mounting location. In some examples, changing the dimensions of a bracket assembly 400 may allow placement of bracket assemblies 400 adjacent to areas of the rounding ring 404 or tank 401 having features where it would be desirable to avoid placing a bracket assembly. For example, a bracket assembly 400 may have a longer tank-facing side of a bracket of the bracket assembly 400, as shown in FIGS. 5A-5C. This variation may allow for a mount of the bracket assembly 400 to be coupled to the tank 401 at a desired distance from the intersection 416 of the rounding ring 404 and the tank 401.

FIGS. 5A-5C illustrate example variations 500A, 500B, 500C of a bracket assembly, such as bracket assembly 400 illustrated in FIG. 4, in accordance with embodiments of the present disclosure. The bracket assembly can include the bracket assembly 201, 300, or 400 or any other bracket assembly in accordance with the present disclosure. As illustrated, a ring-facing leg 506A, 506B, 506C; tank-facing leg 508A, 508B, 508C; or other portion of a bracket assembly may be designed with differing dimensions. For example, one or more dimensions of a bracket 507A, 507B, 507C of respective bracket assemblies 500A, 500B, 500C may be varied based on the specific requirements of the coupling application. Brackets 507A, 507B, 507C may be designed with similar dimensions, such as a width 551A, 551B, 551C of a ring-facing leg 506A, 506B, 506C, to allow for coupling to a rounding ring (not shown) with similar types and/or sizes of mounting locations along the circumference of the rounding ring. Additionally or alternatively, the brackets 507A, 507B, 507C can be designed with some features having different dimensions, such as a depth 553A, 553B, 553C of a tank-facing leg 508A, 508B, 508C. The depth 553A, 553B, 553C of the tank-facing leg 508A, 508B, 508C may be selected to vary a depth 555A, 555B, 555C at which a mount 519A, 519B, 519C of the bracket assembly 500A, 500B, 500C will be configured to couple to or make contact with a surface of the tank 401. The placement of the mount 519A, 519B, 519C may be driven by local variations and/or needs associated with the tank 401 and/or rounding ring 404 geometry, such as those noted above.

Some example non-limiting dimensions of variation 500A can include a width 551A of approximately 3.250 inches, a depth 553A of approximately 2.000 inches, and a depth 555A of approximately of 1.375 inches. Some example non-limiting dimensions of variation 500B can include a width 551B of approximately 3.250 inches, a depth 553B of approximately 3.125 inches, and a depth 555B of approximately of 2.500 inches. Some example non-limiting dimensions of variation 500C can include a width 551C of approximately 3.250 inches, a depth 553C of approximately 9.375 inches, and a depth 555C of approximately of 8.750 inches.

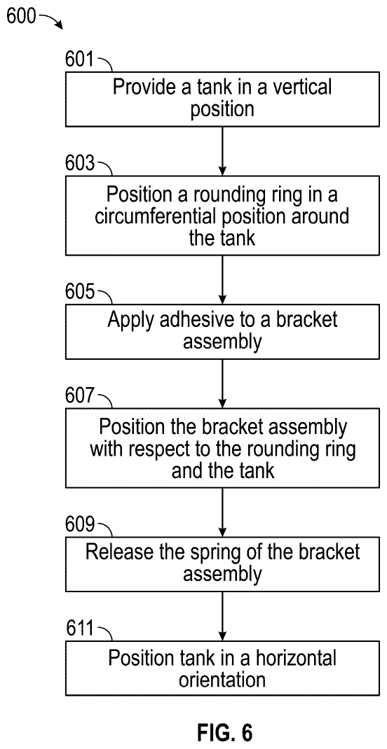

FIG. 6 is an example flowchart of a process 600 of applying a bracket assembly to a rounding ring and a tank in accordance with the present disclosure. In one non-limiting example, the rounding ring 404 is secured to the tank 401 using the process 600, resulting in a plurality of bracket assemblies 400 secured to the rounding ring 404 and the tank 401 as shown in the position illustrated in FIG. 4. A process 600 can include one or more steps that may be performed by a user, operator, and/or machine in whole or in part. While certain components are referred to specifically, such as a rounding ring 404 or tank 401, other component types may be used in addition or in the alternative to the described components and/or some steps may be combined, repeated, or omitted. It will also be understood that embodiments of bracket assemblies according to the present disclosure can be used to couple other types of components, other than a rounding ring 404 and tank 401.

The process 600 begins at a step 601, in which an operator may provide a tank 401 in a vertical position. For example, the tank 401 may be provided in an orientation such that a longitudinal axis of the tank 401 is approximately perpendicular to the ground. This orientation can be helpful to prevent slippage of the rounding ring and/or bracket assemblies when the assembled tank and rounding ring are later transferred to a horizontal position (for example as illustrated in FIG. 1A) or other working position.

The process 600 next moves to a step 603, in which an operator may position at least a portion of a rounding ring 404 in a circumferential position around the tank 401. As noted above, a rounding ring 404 may be referred to as a stiffener ring, ring stiffener, reinforcing ring, or the like. The rounding ring 404 may provide support to maintain the shape the tank 401. For example, a rounding ring 404 may provide circumferential reinforcement to help prevent modes of failure of the tank 401 during use or work on the tank 401. A placement of a rounding ring 404 may be determined based on support needs and/or geometrical considerations. In some examples, placement of a rounding ring 404 may be at certain intervals along the circumference of a portion of the tank 401. Other positioning may also be possible. In some examples, a rounding ring 404 may have an inner diameter that is slightly greater than an outer diameter of the tank 401. In other examples, the rounding ring 404 may have an inner diameter that is significantly greater than the outer diameter of the tank 401. In such examples, a gasket, such as but not limited to a gasket 411 illustrated in FIG. 4, may be positioned between the inner diameter of the rounding ring 404 and the outer diameter of the tank 401. In some examples, individual portions of a rounding ring 404 may be positioned around the tank 401 in pieces. In such examples, the step 603 can include coupling the individual portions of the rounding ring 404 to each other to form a complete rounding ring 404 around the circumference of the tank 401. In some examples, other support components may be positioned in addition to or in the alternative to the rounding ring 404 or portion of the rounding ring 404.

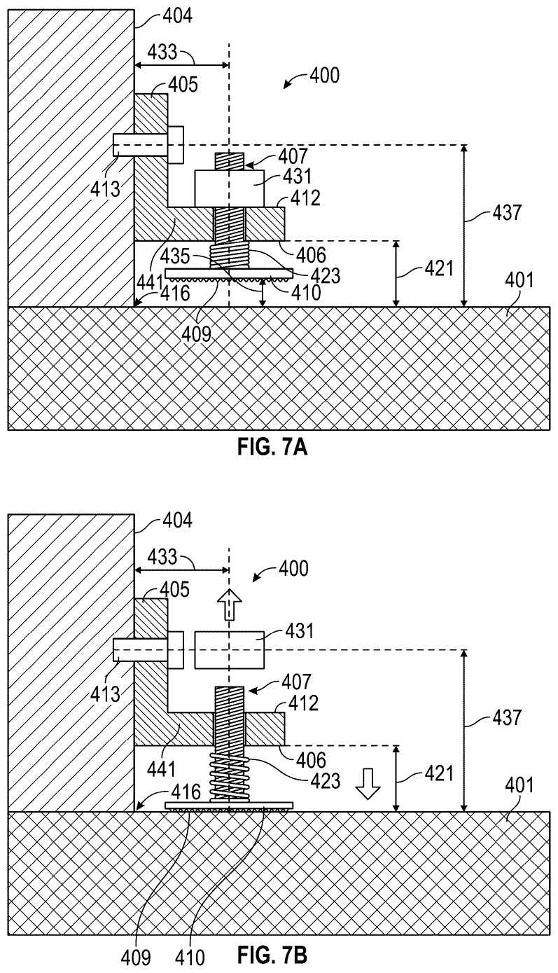

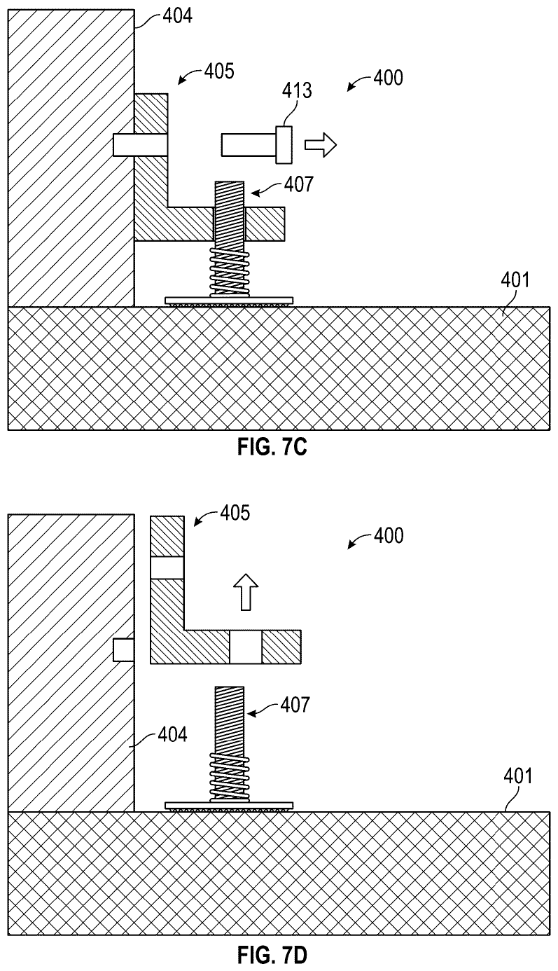

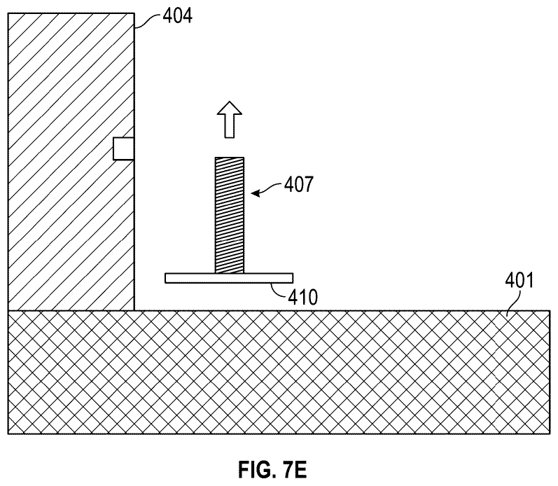

The process 600 next moves to a step 605, in which an operator may apply an adhesive to the bracket assembly 400, such as an adhesive 409 described above with reference to FIG. 4. Accordingly, the bracket assembly 400 may already have an adhesive 409 applied prior to coupling the bracket assembly 400 to the rounding ring 404. The adhesive 409 may be a temporary, permanent, or semi-permanent adhesive configured to couple or bond surfaces, such as a surface of the tank 401 and a tank-facing side 410 of the mount 407 as illustrated in FIG. 4. The adhesive 409 may be glue, cement, paste or any substance. The adhesive 409 may be applied to a part of the bracket assembly 400 that faces the tank 401, such that the adhesive 409 couples the tank 401 and the mount 407 of the bracket assembly 400, such as illustrated in FIG. 7B. For example, the adhesive 409 can be configured to be applied to the tank-facing side 410 of the mount 407 of the bracket assembly 400 and bind, at least temporarily, the bracket assembly 400 to the tank 401 (such as described above with reference to FIGS. 3A-3B). However, other implementations are also possible. For example, in another non-limiting example, the adhesive 409 can be applied to an open space or void between the bracket assembly 400 and the surface of the tank 401, for example the open space or void between the tank-facing side 410 of the mount 407 and the surface of the tank 401. In such embodiments, the adhesive 409 can be applied using an applicator configured to fit in an area defined at least in part by the displacement distance 435. In still another non-limiting example, the adhesive 409 can be applied to a surface of the tank 401 in an area at or near the site of installation of the bracket assembly 400.

The process 600 next moves to a step 607, in which an operator may position a bracket assembly with respect to the rounding ring 404 and the tank 401. However, it is of note that a bracket assembly may be coupled to the rounding ring 404 prior to positioning the rounding ring 404 around the tank 401.

The bracket assembly can include the bracket assembly 201, 300, 400, 500A-500C, or any other bracket assembly in accordance with the present disclosure. The positioning of the bracket assembly may involve aligning one or more openings and/or bushings associated with the bracket assembly with one or more openings and/or bushings associated with the rounding ring 404, such that one or more bolts and/or nuts may be applied to couple the bracket assembly to the rounding ring 404. As shown in FIG. 4, a rounding ring 404 may include one or more openings 415 configured to receive a fastener 413 associated with the bracket assembly 400, such as a fastener 309 described with reference to FIGS. 3A-3B. In some examples, any individual bracket assembly of a plurality of bracket assemblies may be configured to couple to the rounding ring 404 in more than one location of a plurality of locations along the rounding ring. In some examples, an individual bracket assembly of a plurality of bracket assemblies may be configured to couple to only one single location of a plurality of locations along the rounding ring 404. In some examples, the positioning of the bracket assembly may be at the intersection 416 or approximately at the intersection of the rounding ring 404 and the tank 401. The intersection 416 may include a gasket 411, such as described above with reference to FIG. 4.

FIG. 7A illustrates an example cross-sectional side view of a system including a bracket assembly 400, such as the bracket assembly illustrated in FIG. 4. The bracket assembly 400 can include any of the features described with reference to bracket assembly 201, bracket assembly 300, and bracket assemblies 500A, 500B, 500C. The bracket assembly 400 can be placed with respect to a rounding ring, such as the rounding ring 404 described with reference to step 605 of the process 600 above. As illustrated, the bracket assembly 400 may be positioned on the rounding ring 404 by one or more fasteners 413 at a distance 437 from the surface of the tank 401 to maintain a distance 421 between the tank-facing side 406 of the first leg 441 of the bracket 405 and the surface of the tank 401. The distance 421 between the tank-facing side 406 of the first leg 441 of the bracket 405 and the surface of the tank 401 may be selected based on one or more factors, for example the desired contact pressure between a mount 407 of the bracket assembly 400 and the surface of the tank 401 (such contact pressure applied through the adhesive interposed between the mount 407 and the surface of the tank 401, as described herein). The desired contact pressure can be based on factors, including, but not limited to, the distance 421, initial displacement 435 of the tank-facing side 410 of the mount 407 from the surface of the tank 401, and the spring constant of the elastic device 423. As illustrated in FIG. 7B, when the fastener 431 is removed from the bracket assembly 400 to allow the elastic device 423 to decompress, the initial displacement 435 reduces to a second displacement, allowing adhesive 409 on the tank-facing side 410 of the mount 407 to come into contact with the surface of the tank 401. The pressure applied by the tank-facing side 410 of the mount 407 to the tank 401 (through the adhesive) is approximately equivalent to the pressure applied by the elastic device 423 to the second side 412 of the mount 407.

The initial displacement 435 for a given bracket assembly 400 of a plurality of bracket assemblies 400 can vary based on, for example, the spatial relationship and local conditions of the tank 401 and the rounding ring 404 where the given bracket assembly 400 is installed. As a result, a distance that the tank-facing side 410 of the mount 407 in each bracket assembly 400 moves can be different, even in cases where the plurality of bracket assemblies 400 include the same or identical components. Advantageously, embodiments of bracket assemblies 400 according to the present disclosure can account for these variances in local conditions. For example, the elastic device 423 of each of a plurality of bracket assemblies 400 can be pre-compressed to a predetermined or pre-established compression spring force before coupling the bracket assemblies to the rounding ring 404 and the tank 401, and then the distance each elastic device 423 moves its respective mount 407 can be different at each installation site. As such, bracket assemblies 400 according to the present disclosure can be modular or interchangeable, such that any single bracket assembly 400 of a plurality of modular bracket assemblies 400 can be used at any of a plurality of installation sites around the rounding ring 404, while still efficiently and reliably coupling the rounding ring 404 to the tank 401.

The process 600 next moves to a step 609, in which an operator may release an elastic device 423 of each bracket assembly 400 to couple the bracket assembly 400 to the tank 401 using the adhesive 409. The elastic device 423 can be a spring 423, such as a spring 303 of the bracket assembly 300 of FIGS. 3A-3B, but other elastic elements can be suitably implemented. A result of this process is illustrated in FIG. 7B, in which adhesive 409 on the tank-facing side 410 of the mount 407 of the bracket assembly 400 is in contact with the surface of the tank 401 sometime after removal of a fastener 431 configured to maintain compression of the spring 423. The spring 423 may be released by removal of the fastener 431 which maintained compression of the spring 423 during steps 601, 603, 605, and/or 607 of the process 600. However, another mechanism to maintain compression and release compression of the spring 423 may also be suitably implemented. For example, a spring may be held compressed by a clip or ledge that is released by a lever or other suitable mechanism. Following release of the fastener 431, the spring 423 may provide sufficient pressure on the mount 407 and the adhesive 409 to allow the adhesive 409 to bond to the surface of the tank 401. In some examples, the pressure applied to the tank 401 by the mount 407 may be between 2.5 and 5 psi. However, other amounts of pressure can be suitably implemented.

At the completion of step 609 or during step 609, the adhesive 409 may be cured. After curing, the result is that the bracket assembly 400 is secured to both the rounding ring 404 and the tank 401. The process 600 may then move to step 611 in which the tank 401 is positioned in a horizontal orientation. For example, in some examples, a tank 401 may be placed in, on, or near a machine configured to affect a circumferential weld, such as a horizontal circumferential weld. A tank 401 may be provided in a position that is not horizontal. However, it can be advantageous in certain applications to provide a tank 401 in a horizontal position where a tank 401 is large (such as, for example, 20 feet or greater in diameter) because it can be more space efficient and easier to maneuver the tank 401 than when the tank 401 is provided in a vertical or other position. Once the tank is in the desired working position, a welding process may then be commenced or other function or work on the tank 401 can be performed.

It will be understood that embodiments of the present disclosure are not limited to providing a tank (or other structure) in a vertical position initially, and can be suitably implemented when the tank (or other structure) are positioned in a non-vertical orientation. Accordingly, in other non-limiting examples of the process 600, the tank 401 is provided in a horizontal orientation at step 601, and maintained in a horizontal position during steps 603, 605, 607, and/or 609. In such examples, the process 600 omits step 611.

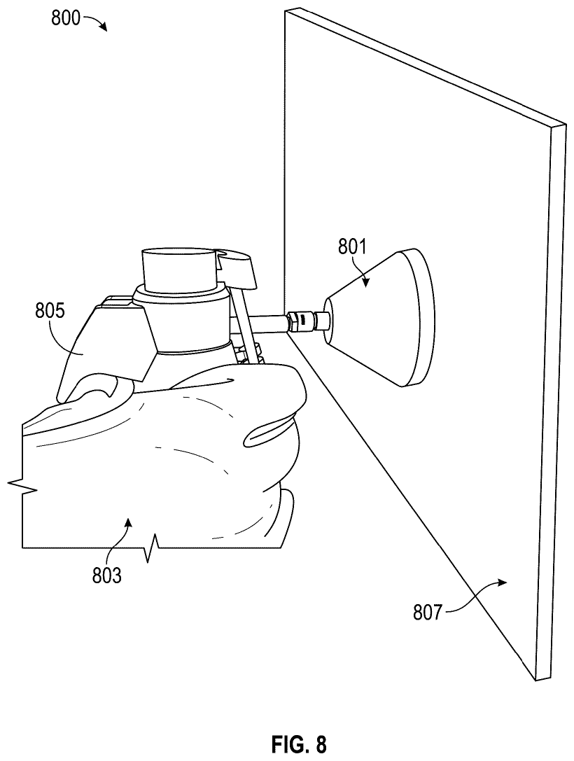

During work on the tank 401 or after work on the tank 401 is complete, the bracket assembly 400 may be removed from the tank 401 and/or rounding ring 404. The removal process may include (not necessarily in the recited sequence): removing the fastener 413 that is coupling the bracket assembly 400 to the rounding ring 404 (as illustrated in FIG. 7C); lifting, removing, or otherwise separating the bracket assembly 400 from the mount 407 that is coupled to the tank 401 (as illustrated in FIG. 7D); and removing the mount 407 from the tank 401 (as illustrated in FIG. 7E and described with reference to FIG. 8). It is of note that the one or more components or the bracket assembly 400, such as the mount 407, may be removed from the tank 401 before (as illustrated in FIG. 7E) or after the rounding ring 404 is removed from the tank 401. Each of these steps may be performed entirely for each bracket assembly before these steps are performed for other bracket assemblies, or one or more removal steps may be performed for all or a set of bracket assemblies as a group before completing further removal steps. For example, an operator may remove the fasteners 413 coupling the bracket assemblies 400 to the rounding ring 404 and their associated brackets 405 in a specific region or entirely around the circumference of the tank 401. The operator may then remove the mounts 407 around the entirety of the tank 401. The rounding ring 404 itself may be removed after all the brackets 405 have been decoupled from the rounding ring 404. This may or may not occur before the mounts 407 are removed from the tank 401.

The flow chart sequence is illustrative only. A person of skill in the art will understand that the steps, decisions, and processes embodied in the flowchart described herein may be performed in an order other than that described. Thus, the particular flowchart and descriptions are not intended to limit the associated processes to being performed in the specific order described.

FIG. 8 illustrates an example system 800 to remove adhesive from a surface after removing a bracket assembly in accordance with the present disclosure. In the illustrated example, a cryogenic removal tool 805 can be used by an operator 803 to remove a cured adhesive on a tank 807, after removing a bracket assembly as described above (for example with reference to FIGS. 7C-7E). A removal tool can include a funnel 801 configured to direct liquid nitrogen from a cryogenic removal tool 805.

Advantageously, cryogenic removal functions due to the thermo-mechanical properties of certain cured adhesives at cryogenic temperatures. For example, the cured adhesive may be brittle at cryogenic temperatures (for example, the temperature of liquid nitrogen at normal atmospheric pressure-approximately 77K or below), allowing for brittle disbanding of the adhesive after minimal impact once low enough temperatures are reached. However, it is of note that other removal methods are also possible. For example, some adhesives, such as two part acrylics, exhibit softening at certain temperatures (e.g. approximately 150 degrees F. or 340K), allowing for potential removal using heat application, such as with a heat gun. Other mechanical methods, such as inducing moment on a fastener with a lever may also function as an effective removal technique.

The surface of the tank may be cleaned after removal of the adhesive and/or during the adhesive removal process. For example, the surface can be cleaned to its original state or a desired amount by abrasion or other cleaning methods. In some examples, the adhesive removal process itself may sufficiently clean the tank surface.

While the above detailed description has shown, described, and pointed out novel features of the present disclosure as applied to various embodiments, it will be understood that various omissions, substitutions, and changes in the form and details of the device or process illustrated may be made by those skilled in the art without departing from the spirit of the present disclosure. As will be recognized, the present disclosure may be embodied within a form that does not provide all of the features and benefits set forth herein, as some features may be used or practiced separately from others. All changes which come within the meaning and range of equivalency of the claims are to be embraced within their scope.

The detailed description is directed to certain specific embodiments of the present disclosure. Reference to “one embodiment,” “an embodiment,” or “in some embodiments” means that a particular feature, structure, or characteristic described in connection with the embodiment is included in at least one embodiment of the present disclosure. The appearances of the phrases “one embodiment,” “an embodiment,” or “in some embodiments” in various places are not necessarily all referring to the same embodiment, nor are separate or alternative embodiments necessarily mutually exclusive of other embodiments. Moreover, various features are described which may be exhibited by some embodiments and not by others.

The terminology used herein is not intended to be interpreted in any limited or restrictive manner, simply because it is being utilized in conjunction with a detailed description of certain specific embodiments of the present disclosure. Furthermore, embodiments of the present disclosure may include several novel features, no single one of which is solely responsible for its desirable attributes or which is essential to practicing the present disclosure.

The term “comprising” as used herein is synonymous with “including,” “containing,” or “characterized by,” and is inclusive or open-ended and does not exclude additional, unrecited elements or method steps. With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches. For example, terms such as about, approximately, substantially, and the like may represent a percentage relative deviation, in various embodiments, of +1%, +5%, +10%, or +20%.

The above description discloses several methods and materials of the present disclosure. The present disclosure is susceptible to modifications in the methods and materials, as well as alterations in the fabrication methods and equipment. Such modifications will become apparent to those skilled in the art from a consideration of this disclosure. Consequently, it is not intended that the present disclosure be limited to the specific embodiments disclosed herein, but that it covers all modifications and alternatives coming within the true scope and spirit of the present disclosure.

What is claimed is:

1. A device configured to couple a rounding ring to a tank, the device comprising:
a bracket having a first leg angled relative to a second leg, the first leg comprising a tank-facing side and a first opening, the second leg configured to couple to the rounding ring;
a mount comprising a tank-facing side and a stud on a second side opposite the tank-facing side, the tank-facing side of the mount configured to place an adhesive into contact with the tank when the stud is inserted into the first opening of the bracket via the tank-facing side of the first leg of the bracket;
a spring between the second side of the mount and the tank-facing side of the first leg of the bracket when the stud is inserted into the first opening of the bracket; and
a nut configured to couple to the stud and compress the spring when the stud is inserted into the first opening of the bracket and the second leg is coupled to the rounding ring, wherein movement of the nut away from the mount uncompresses the spring to place adhesive on the tank-facing side of the mount into contact with the tank.

2. The device of claim 1, wherein, when the adhesive is placed into contact with the tank, the mount is configured to apply about 2.5 to about 5 pounds per square inch pressure on the adhesive.

3. The device of claim 1, wherein the stud is a threaded stud, and wherein unthreading the nut from the stud moves the nut away from the mount to uncompress the spring.

4. The device of claim 1, wherein the spring is configured to be received around an outer diameter of the stud.

5. The device of claim 1, wherein the second leg of the bracket comprises a second opening configured to receive a fastener configured to couple the second leg of the bracket to the rounding ring.

6. The device of claim 1, wherein the device is configured to couple the rounding ring to a tank having an outer diameter of 20 feet or more.

7. A system comprising:
a rounding ring positioned around a circumference of a tank;
an angled bracket comprising a tank-facing leg and a ring-facing leg;
a flanged post comprising a first side and a second side, the first side configured to place an adhesive into contact with the tank when the flanged post is inserted into an opening in the tank-facing leg of the angled bracket;
an elastic device between the second side of the flanged post and the tank-facing leg of the angled bracket when the flanged post is inserted into the opening of the angled bracket; and
a fastener configured to couple to the flanged post and compress the elastic device when the post is inserted into the opening of the angled bracket and the ring-facing leg is coupled to the rounding ring, wherein movement of the fastener away from the tank-facing leg uncompresses the elastic device to place adhesive on the first side of the flanged post into contact with the tank.

8. The system of claim 7, further comprising a plurality of angled brackets configured to couple the rounding ring to the tank at a plurality of locations around the circumference of the tank.

9. The system of claim 8, wherein the tank-facing leg of a first angled bracket is longer than the tank-facing leg of a second angled bracket of the plurality of angled brackets.

10. The system of claim 8, wherein at least one angled bracket of the plurality of angled brackets couples the rounding ring to the tank every 45 degrees along the circumference of the tank.

11. The system of claim 7, wherein, when the adhesive is placed into contact with the tank, the first side of the flanged post is configured to apply about 2.5 to about 5 pounds per square inch pressure on the adhesive.

12. The system of claim 7, wherein the elastic device comprises a helical compression spring configured to be received around an outer diameter of the flanged post.

13. The system of claim 7, further comprising a second fastener configured to couple the ring-facing leg of the angled bracket to the rounding ring, wherein the ring-facing leg of the angled bracket comprises a second opening configured to receive the second fastener.

14. The system of claim 7, wherein the system is configured to couple the rounding ring to a tank having an outer diameter of 20 feet or more.

15. The system of claim 7, wherein the system is configured to allow the tank to deform along an axis of the flanged post when the adhesive on the first side of the flanged post is placed into contact with the tank.

16. The system of claim 7, wherein the system is configured to allow the tank to deform radially with respect to the rounding ring when the adhesive on the first side of the flanged post is placed into contact with the tank.

17. The system of claim 7, wherein the angled bracket is configured to allow the tank to be coupled to the rounding ring when a major axis of the tank is parallel to the ground.

18. A method of coupling a rounding ring to a tank, the method comprising:
positioning a rounding ring around a circumference of the tank;
providing a kit comprising
an angled bracket comprising a tank-facing leg and a ring-facing leg,
a flanged post comprising a first side and a second side, the first side configured to place an adhesive into contact with the tank when the flanged post is inserted into an opening in the tank-facing leg of the angled bracket,
an elastic device between the second side of the flanged post and the tank-facing leg of the angled bracket when the flanged post is inserted into the opening of the angled bracket, and
a fastener configured to couple to the flanged post and compress the elastic device when the post is inserted into the opening of the angled bracket and the ring-facing leg is coupled to the rounding ring, wherein movement of the fastener away from the tank-facing leg uncompresses the elastic device to place adhesive on the first side of the flanged post into contact with the tank; and
coupling the tank-facing leg of the angled bracket to the tank and the ring-facing leg of the angled bracket to the rounding ring.

19. The method of claim 18, wherein coupling the tank-facing leg of the angled bracket to the tank and the ring-facing leg of the angled bracket to the rounding ring comprises:
positioning the elastic device around the flanged post;
inserting the flanged post into an opening in the tank-facing leg of the angled bracket such that the elastic device is positioned between the second side of the flanged post and the tank-facing leg of the angled bracket;
compressing the elastic device between the second side of the flanged post and the tank-facing leg of the angled bracket;
coupling the ring-facing leg of the angled bracket to the rounding ring;
placing an adhesive on the first side of the flanged post; and
uncompressing the elastic device to place the adhesive into contact with the tank.

20. The method of claim 19, wherein the kit further comprises a fastener configured to couple to the flanged post.

21. The method of claim 20, wherein compressing the elastic device between the second side of the flanged post and the tank-facing leg of the angled bracket comprises fastening the fastener to the flanged post.

22. The method of claim 21, wherein uncompressing the elastic device comprises unfastening the fastener from the flange post.

23. The method of claim 19, wherein uncompressing the elastic device applies about 2.5 to about 5 pounds per square inch pressure on the adhesive in contact with the tank.

24. The method of claim 19, further comprising using a cryogenic technique to remove the adhesive in contact with the tank.

25. The method of claim 18, further comprising coupling the rounding ring to the tank at a plurality of locations around the circumference of the tank using a plurality of kits.

26. The method of claim 25, wherein the rounding ring is coupled to the tank at every 45 degrees along the circumference of the tank using at least one kit.

27. The method of claim 18, wherein the tank has an outer diameter of 20 feet or more.

28. The method of claim 18, wherein the tank is in a vertical orientation when the rounding ring is coupled to the tank.
